(19) United States
(12) Patent Application Publication
(10) Pub. No.: US 2015/0305328 A1
(43) Pub. Date: Oct. 29, 2015

(54) METHODS OF SAFENING SUGAR CANE PLANTS WITH N-ACYLSULFAMOYLPHENYLUREAS

(71) Applicants: Gavin John HALL, Bracknell, Berkshire (GB); Christoph WEBER, Cambridge (GB); Natalie DUPEN, Bracknell, Berkshire (GB); Jose CLAUDIONIR, Sao Paulo (BR); Albrecht MICHEL, Basel (CH); Domingos PEDRONI, Sao Paulo (BR)

(72) Inventors: Gavin John HALL, Bracknell, Berkshire (GB); Christoph WEBER, Cambridge (GB); Natalie DUPEN, Bracknell, Berkshire (GB); Jose CLAUDIONIR, Sao Paulo (BR); Albrecht MICHEL, Basel (CH); Domingos PEDRONI, Sao Paulo (BR)

(73) Assignee: SYNGENTA PARTICIPATIONS AG, Basel (CH)

(21) Appl. No.: 14/385,488

(22) PCT Filed: Mar. 13, 2012
(86) PCT No.: PCT/IB2012/000554

§ 371 Date: Jun. 2, 2015

(51) Int. Cl. A01N 25/32; A01N 37/22; A01N 39/02; A01N 47/34

(52) U.S. Cl. CPC A01N 25/32; A01N 47/34; A01N 37/22; A01N 39/02

(57) ABSTRACT

The present technology is a novel method for reducing the phytotoxicity of herbicides to sugar cane plants, which comprises applying to the sugar cane propagation material, prior to sowing, a phytotoxicity reducing effective amount of a Formula (II) and/or Formula (III); or an agronomically acceptable salt of said compounds.

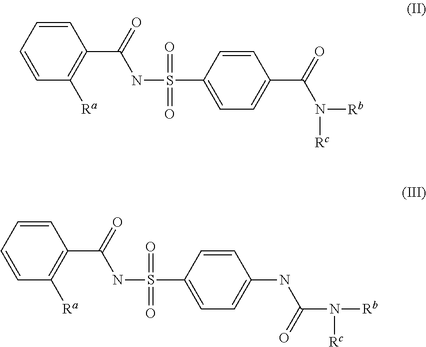

The method of the present invention in provides for reduced phytotoxicity for gramineous crop plants, such as sugar cane and bamboo.

Sugarcane is commonly used for the production of sugar, Falernum, molasses, rum, cachaça, and ethanol for fuel. Further, the biomass that remains after sugarcane crushing can also be used in furnaces and boilers.

Most commercial sugarcane is grown from stem sections (also known as cane cuttings or parts of a stalk or culms or carretels or seedlings). The stem of sugar cane comprises generally several nodes and internodes as in other grasses. Suitable material for cuttings are pieces of cane cut from 8-14 month old healthy plants, with the older basal buds or buds in the middle to top of the stem germinating stronger and faster. The cuttings are taken from plants which themselves have generally grown from cuttings. Stem sections may be produced from the stem of a sugarcane plant in any number of ways. For example, they may be formed manually or by a variety of machines. The resulting stem sections usually include several nodes per stem section. The term “node” means the part of the stem of a plant from which a leaf, branch, or aerial root grows.

After stem sections are planted, buds (or gemmas) may emerge at the position of each node. Buds may then grow to yield the crop plant. However, emergence rate, or the rate at which nodes bud to yield crop plants is sometimes poor in sugarcane. To improve the likelihood that each planted stem section will produce crop plants, stem sections are often planted with multiple nodes, e.g., 3, 4 or 5 nodes per stem section. These multi-node stem sections (or long stem sections) may have lengths of about 37 cm, 40 cm or greater.

More recently, certain technologies enabling the sowing of single-node stem sections has been developed. These single-node stem sections are shorter than the standard 3-5 node stem sections and generally range from about 2 to about 12 cm in length. More suitably, the single-node stem sections are from about 3 to about 8 cm in length.

The present technology relates to N-acylsulfamoylphenylureas of the Formula (II) and/or Formula (III);

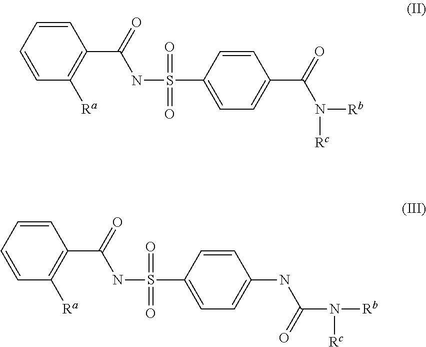

or an agronomically acceptable salt of said compounds, wherein:

R^{a} is selected from the group consisting of halogen, nitro, C₁-C₄ alkyl, C₁-C₄ haloalkyl, C₁-C₄ haloalkoxy, C₃-C₆ cycloalkyl, phenyl, C₁-C₄ alkoxy, cyano, C₁-C₄ alkylthio, C₁-C₄ alkylsulfinyl, C₁-C₄ alkylsulfonyl, C₁-C₄ alkoxycarbonyl and C₁-C₄ alkylcarbonyl; and

R^{b} and R^{c} are independently selected from the group consisting of hydrogen, C₁-C₆ alkyl, C₃-C₆ cycloalkyl, C₃-C₆ alkenyl and C₃-C₆ alkynyl, that are suitable for applying to the plant propagation material of sugar cane and thereby protect sugar cane plants from the phytotoxic action of applied herbicides.

The term “propagation material” or “plant propagation material” means seeds, parts of plants and all plant material, including rootstocks, intended for the propagation and production of plants.

Certain N-acylsulfamoylphenylureas compounds and their use as co-applied herbicidal safeners with soil or foliar herbicides belonging to the classes of the sulfonylureas, haloacetanilides and aryloxyphenoxypropionic acid derivatives are known and described in U.S. Pat. No. 5,215,570. Such prior uses are described in U.S. Pat. No. 5,215,570 for its applicability to cereals, soybeans, maize, and rice.

The present technology also relates to a method of selectively controlling weeds at a locus comprising sugar cane propagation material and weeds, wherein the method comprises application to the locus of a weed a controlling amount of a herbicide, and wherein the sugar cane propagation material has been treated with phytotoxicity reducing effective amount of a N-acylsulfamoylphenylurea of the formula (II) or formula (III), as defined above, or an agronomically acceptable salt of said compounds.

The term “controlling” means killing, reducing or retarding growth or preventing or reducing germination. Generally the plants to be controlled are unwanted vegetation (weeds). The term “locus” means the area in which the plants are growing or will grow.

It is known that herbicides belonging to certain classes of chemistry, when employed in an effective concentration, occasionally damage cultivated plants to a certain extent in addition to the weeds that are to be controlled. Overdoses are often applied unintentionally and accidentally when edge zones overlap during stripwise spraying, either as a result of wind or as a result of incorrect judgment of the effective width of the spraying apparatus. The climatic conditions or the nature of the soil may be such that the concentration of herbicide recommended for normal conditions acts as an overdose. The quality of the seeds may also be a factor in the tolerance of the herbicide. To counteract this problem, various substances have already been proposed which are able specifically to antagonise the harmful action of the herbicide on the cultivated plant, i.e. to protect the cultivated plant without noticeably influencing the herbicidal action on the weeds to be controlled. However, it has been found that the proposed counter-agents often have very species-specific activity both with respect to the cultivated plants and with respect to the herbicide and also, in some cases, contingent on the mode of application, i.e. a specific counter-agent is often suitable only for a specific cultivated plant and a few classes of herbicide, or with herbicides have a certain mode of action.

Surprisingly, it has now been found that the application of N-acylsulfamoylphenylureas of the Formula (II) and/or Formula (III) can be applied to the sugar cane propagation material prior to planting/sowing. Thereafter the propagation material is planted/sown. It has been found that this method of applying to the propagation material results in providing for the protection of the sugar cane plant from the harmful effects of later applied soil, foliar, post-emergent, and pre-emergent herbicides.

It has surprisingly now been found that a group of N-acylsulfamoylphenylureas are suitable for application to sugar cane plant propagation pieces for protecting cultivated plants against the damaging effect herbicides. These N-acylsulfamoylphenylureas are therefore referred to in the following text also as “counter-agents,” “antidotes,” or “safeners”.

Herbicides are commonly used as a solution to controlling unwanted vegetation. Unwanted vegetation, or weeds, is to be understood as those plants that affect the growth and quality of the sugarcane. Examples of weeds include grasses, sedges and broad-leaved weeds. With regard to sugarcane—examples of unwanted vegetation typically include Ipomoea spp. (e.g Ipomoea grandifolia, Ipomoea acuminate, Ipomoea nil, Ipomea hederaceá), Echinochloa spp., Digitaria spp. (e.g Digitaria horizontalis), Setaria spp., Sorghum spp., Brachiaria spp. (e.g Brachiaria decumbens and Brachiaria plantagineá), Kochia spp., Sida spp. (e.g Sida rhombifolia), Portulaca spp. (e.g Portulaca oleracea), Panicum spp. (e.g Panicum maximum), Cenchrus spp. (e.g Cenchrus echinatus), Cyperus spp, Eleusine spp. (e.g Eleusine indica), Chenopodium spp., Euphorbia spp. (e.g Euphorbia heterophyllá) and Amarathus spp. (e.g Amaranthus viridis. Amaranthus retroflexus, Amaranthus hybridus).

The control of the unwanted vegetation ensures satisfactory crop yield and quality, and the grower of the crop has often to balance the costs associated with the use of compounds with the resulting yield, but generally an increase of, for example, at least 5% yield of a crop which has undergone compound treatment compared with an untreated crop is considered control by the compound.

It should also be appreciated that the one or more additional pesticides e.g herbicides, herbicide safeners, plant growth regulators, fertilizers, insecticides and/or fungicides, may be applied to the locus in the method of the present invention. It should be understood that the one or more additional pesticides may also be applied to sugarcane propagation material.

Application to the plant propagation material can be performed using a variety of standard application methods. Application methods for applying chemical treatments to plant propagation material are well known in the art and include, for example, dipping or soaking the plant propagation material, applying via a spray or liquid curtain, and drench applications. Drench applications are applications in which the propagation material is placed in the planting furrow and the treatment is applied to the propagation material, the propagation material is then sown.

The present technology relates to N-acylsulfamoylphenylureas of the Formula (II) and/or Formula (III):

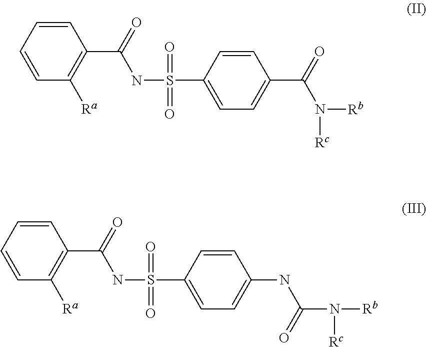

or an agronomically acceptable salt of said compounds, wherein:

R^{a} is selected from the group consisting of halogen, nitro, C₁-C₄ alkyl, C₁-C₄ haloalkyl, C₁-C₄ haloalkoxy, C₃-C₆ cycloalkyl, phenyl, C₁-C₄ alkoxy, cyano, C₁-C₄ alkylthio, C₁-C₄ alkylsulfinyl, C₁-C₄ alkylsulfonyl, C₁-C₄ alkoxycarbonyl and C₁-C₄ alkylcarbonyl; and

R^{b} and R^{c} are independently selected from the group consisting of hydrogen, C₁-C₆ alkyl, C₃-C₆ cycloalkyl, C₃-C₆ alkenyl and C₃-C₆ alkynyl, that are suitable for applying to the plant propagation material of sugar cane and thereby protect sugar cane plants from the phytotoxic action of applied herbicides.

In one embodiment of the technology, the N-acylsulfamoylphenylureas is of the Formula (III) wherein R^{a} is methoxy and R^{b} and R^{c} are independently selected from the group consisting of hydrogen and methyl. In one embodiment of Formula (III) the compound is 1-[4-(N-2-methoxybenzoylsulfamoyl)phenyl]-3-methylurea.

In another embodiment of the technology the N-acylsulfamoylphenylureas is of the Formula (II) wherein R^{a} is methoxy and R^{b} and R^{c} are independently selected from the group consisting of hydrogen and cyclopropyl. In one embodiment of Formula (II) the compound is N-[[4-[(cyclopropylamino)carbonyl]phenyl] sulfonyl]-2-methoxybenzamide.

### EXAMPLES

In the following examples, two commercial and contemporary Brazilian sugar cane varieties were used in the experiential testing, SP803280 and RB835486. The sugar cane propagation material was prepared using single-node stem sections approximately 8 cm in length. The stem sections were treated by soaking for about 10 seconds in a solution containing Formula A=1-[4-(N-2-methoxybenzoylsulfamoyl)phenyl]-3-methylurea (15 ml of formulated product in 500 ml water; the formulated product contained 100 grams of Formula A per liter of formulated product). Four stem segments (replicates) were planted in and covered with 1 cm of the regular live loam soil used in glasshouse screening using standard planting troughs, putting each variety in a separate trough. Seeds of one of two appropriate weeds, Euphorbia heterophylla or Brachiaria decumbens were also planted in each trough in a clump to give a measure of relative weeds control alongside crop phytotoxicity. Plants were assessed for percentage visual phytotoxicity at 7 day intervals after application (DAA) up to 35 DAA. Three herbicides, all having different modes-of-action were applied the day after planting as pre-emergent herbicide. The herbicides applied were: clomazone (Gamit®) having a DOXP mode-of-action (inhibition of the 1-desoxy-D-xylulose 5-phosphate), sufentrazone (Boral®) having a PPO mode-of-action (inhibition of protoporphyrinogen oxidase), and bicyclopyrone having an HPPD mode-of-action (inhibition of the enzyme 4-hydoxyphenylpyruvate dioxygenase). Application of each herbicide was applied at 600, 1200, 1600, and 2000 grams per hectare equivalents.

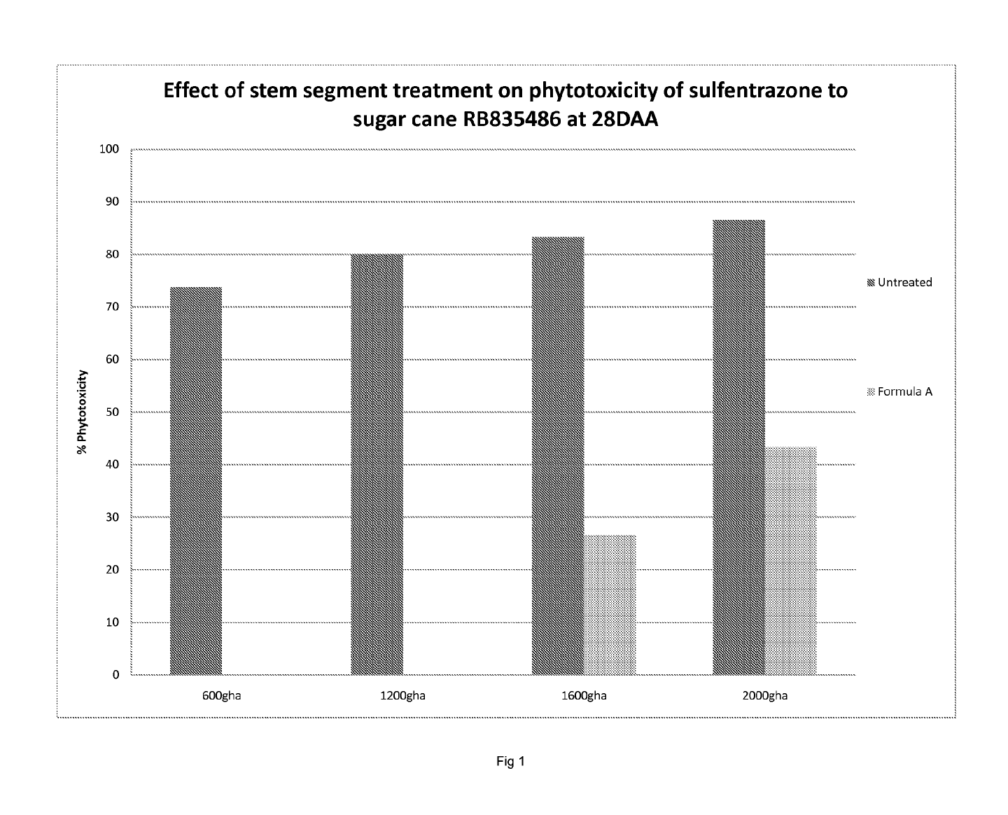

Results: Shown in FIGS. 1-12 (DAA—Herbicide—Sugar Cane Variety)

FIG. 1: 28 DAA—sulfentrazone—RB835486

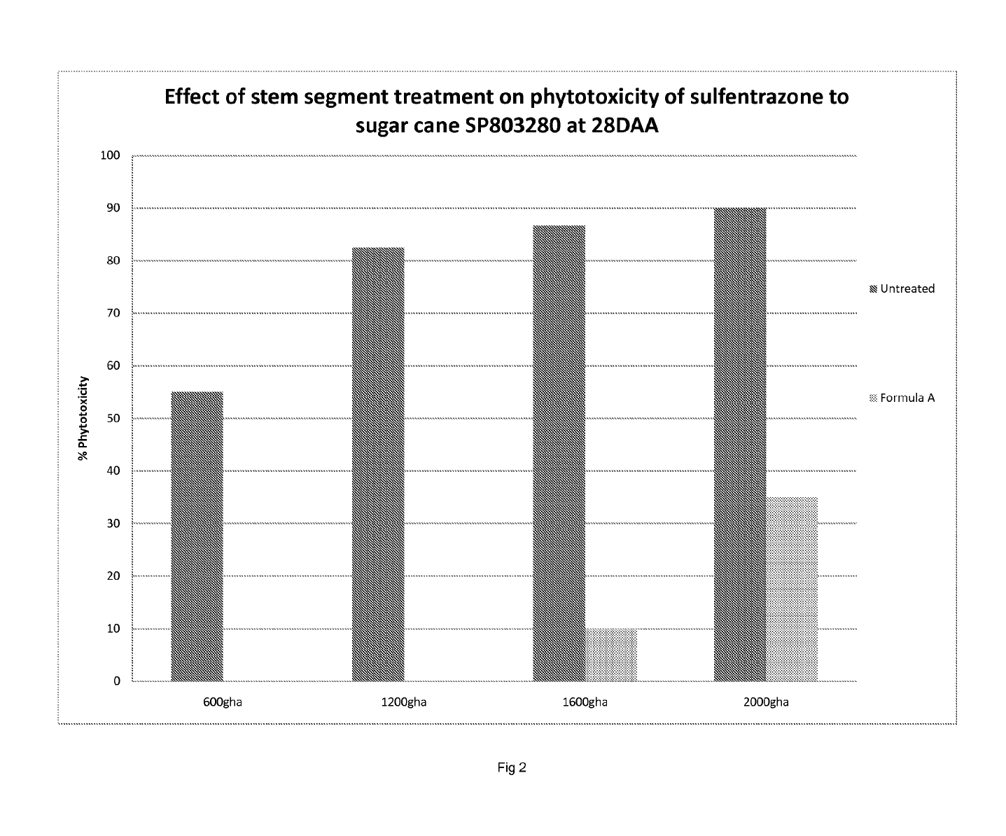

FIG. 2: 28 DAA—sulfentrazone—SP803280

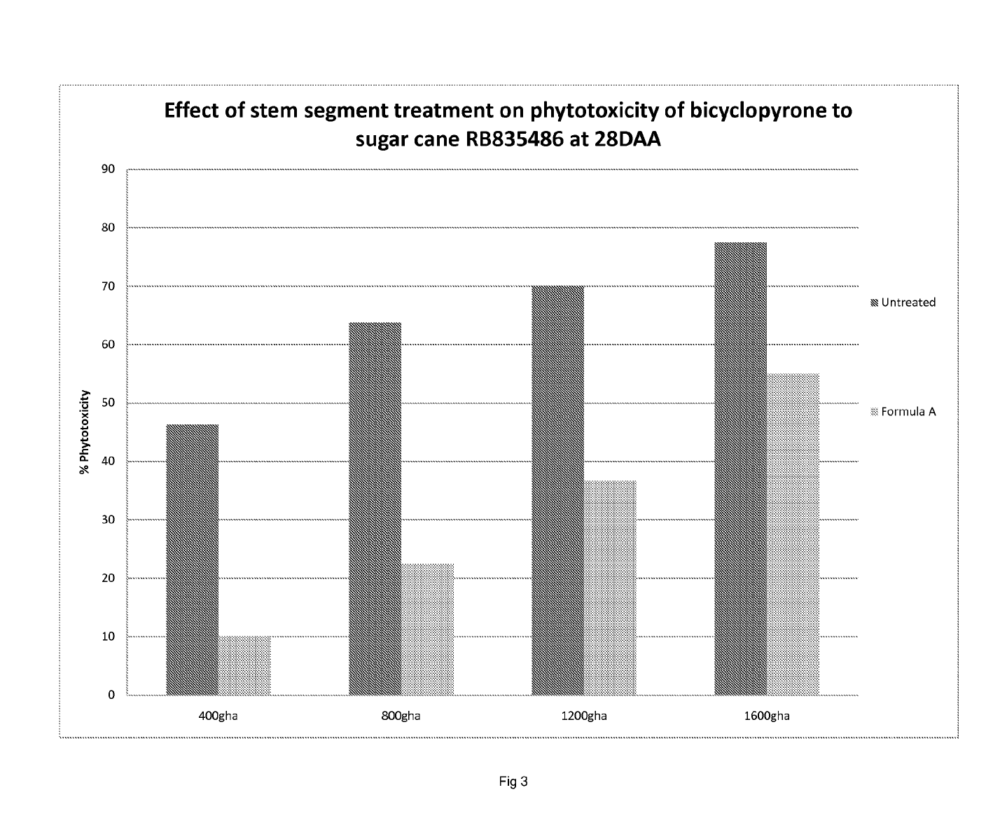

FIG. 3: 28 DAA—bicyclopyrone—RB835486

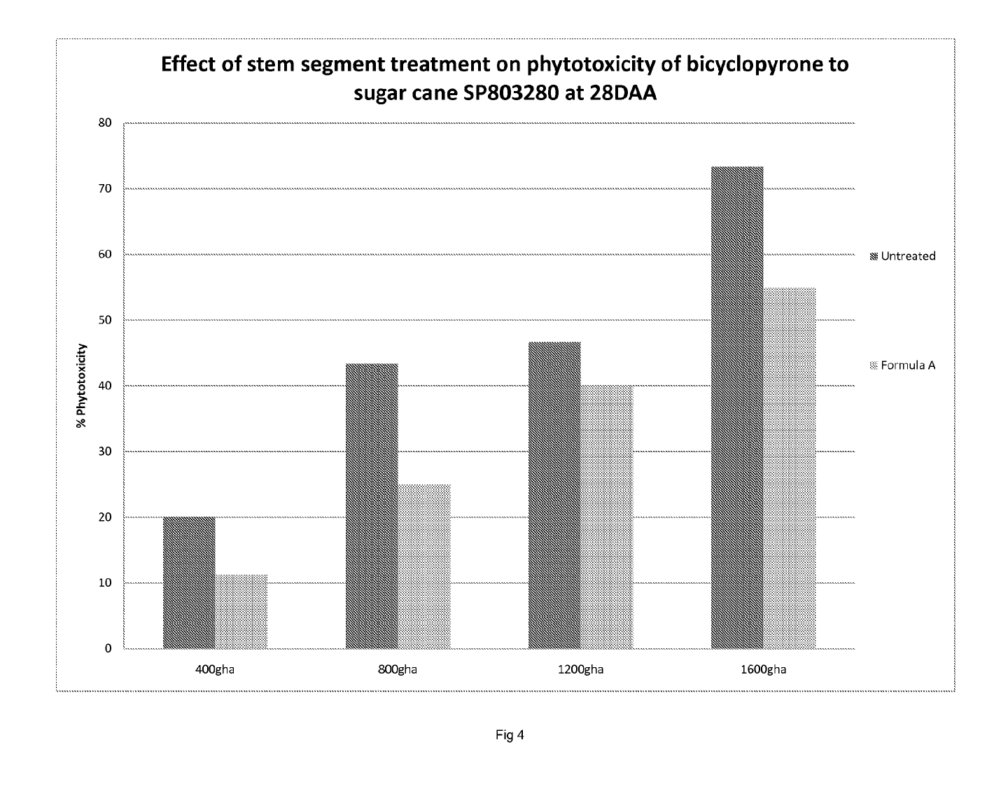

FIG. 4: 28 DAA—bicyclopyrone—SP803280

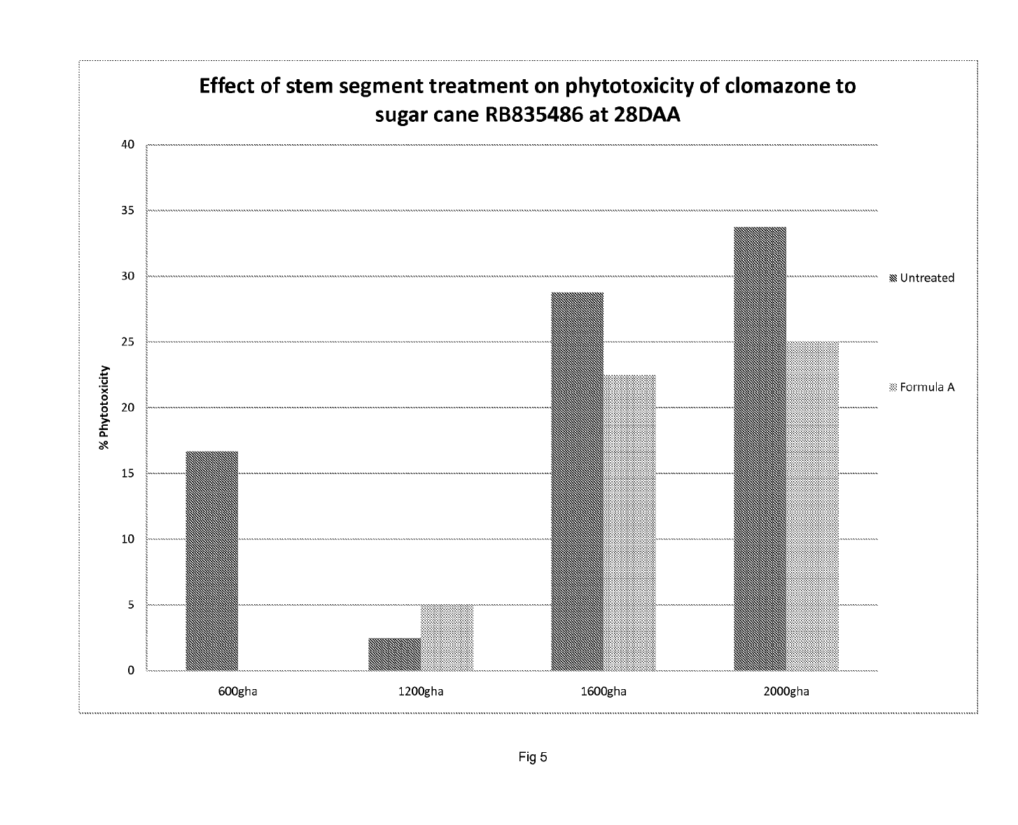

FIG. 5: 28 DAA—clomazone—RB835486

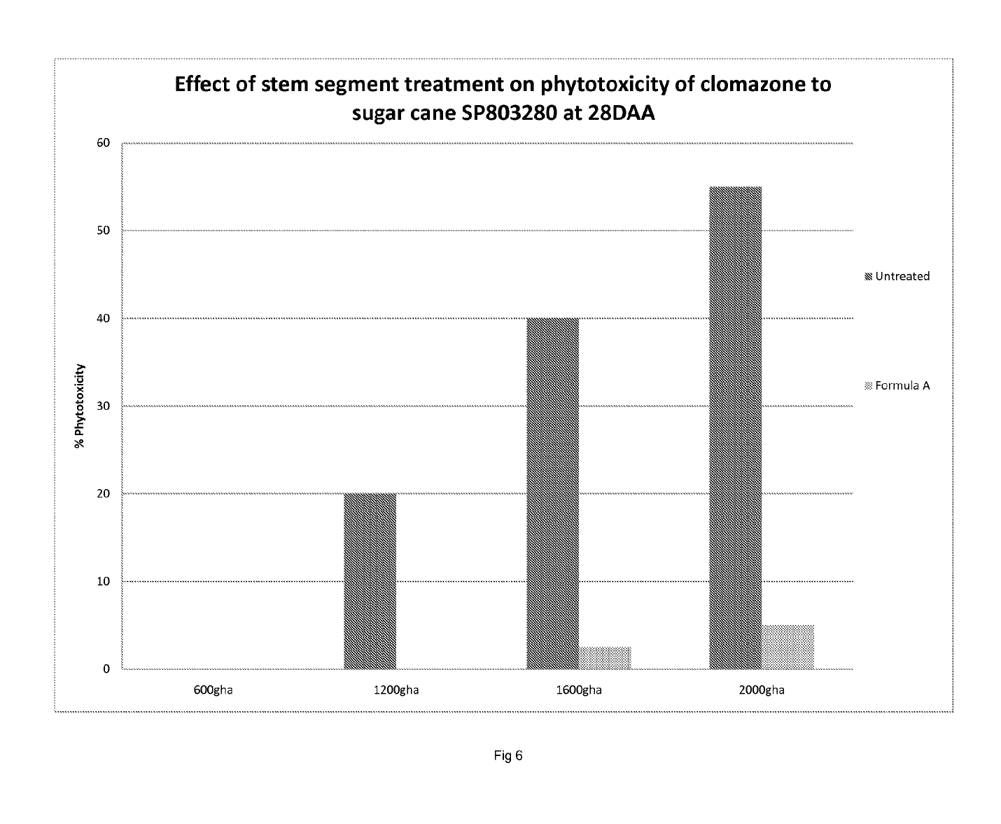

FIG. 6: 28 DAA—clomazone—SP803280

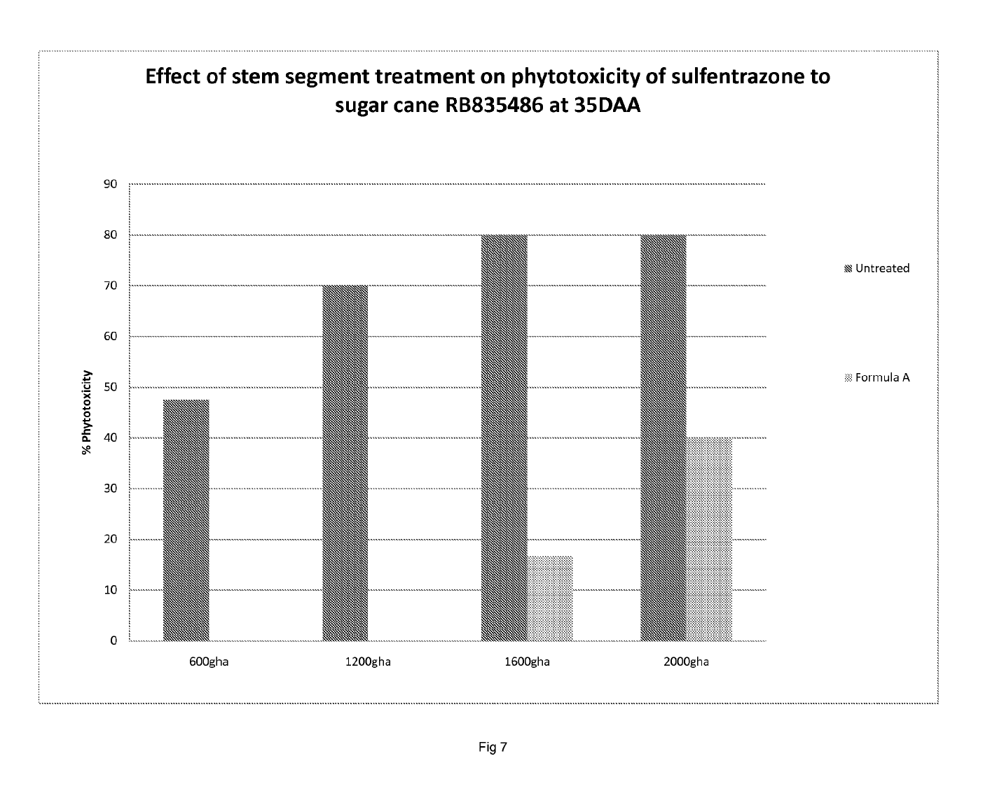

FIG. 7: 35 DAA—sulfentrazone—RB835486

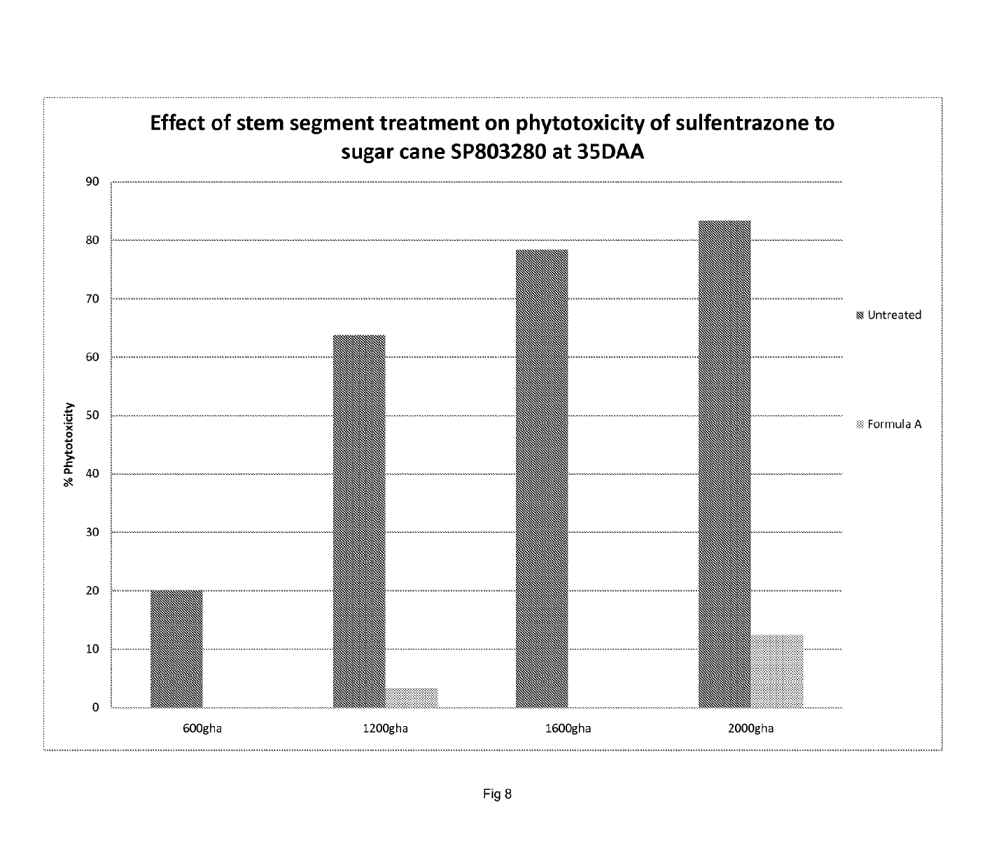

FIG. 8: 35 DAA—sulfentrazone—SP803280

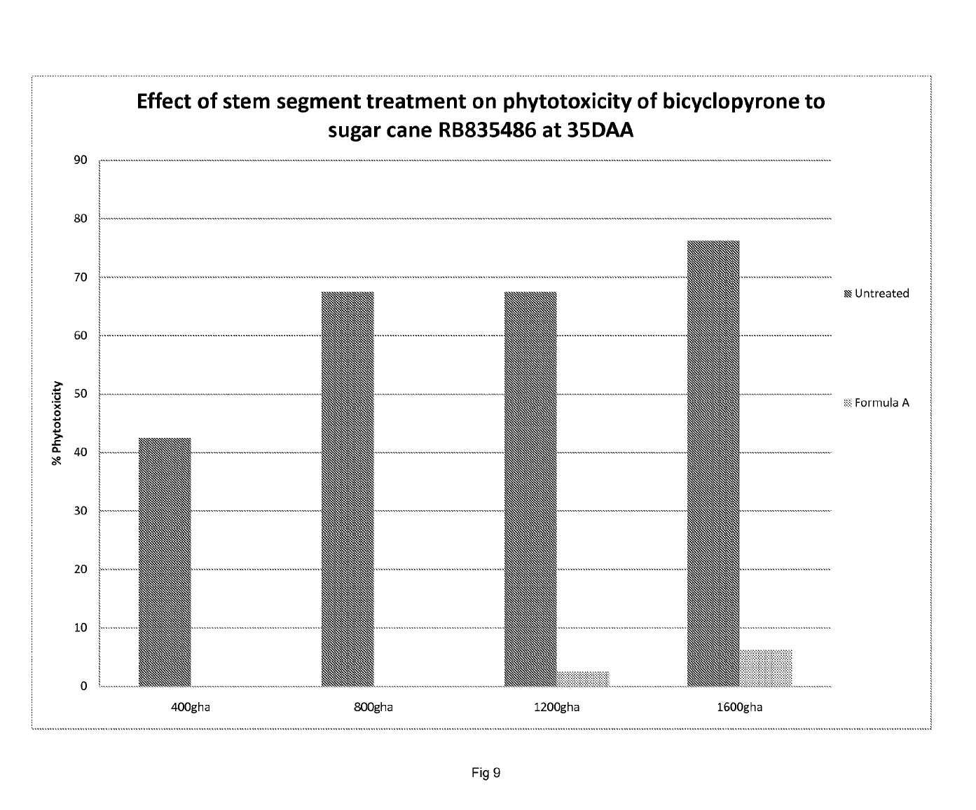

FIG. 9: 35 DAA—bicyclopyrone—RB835486

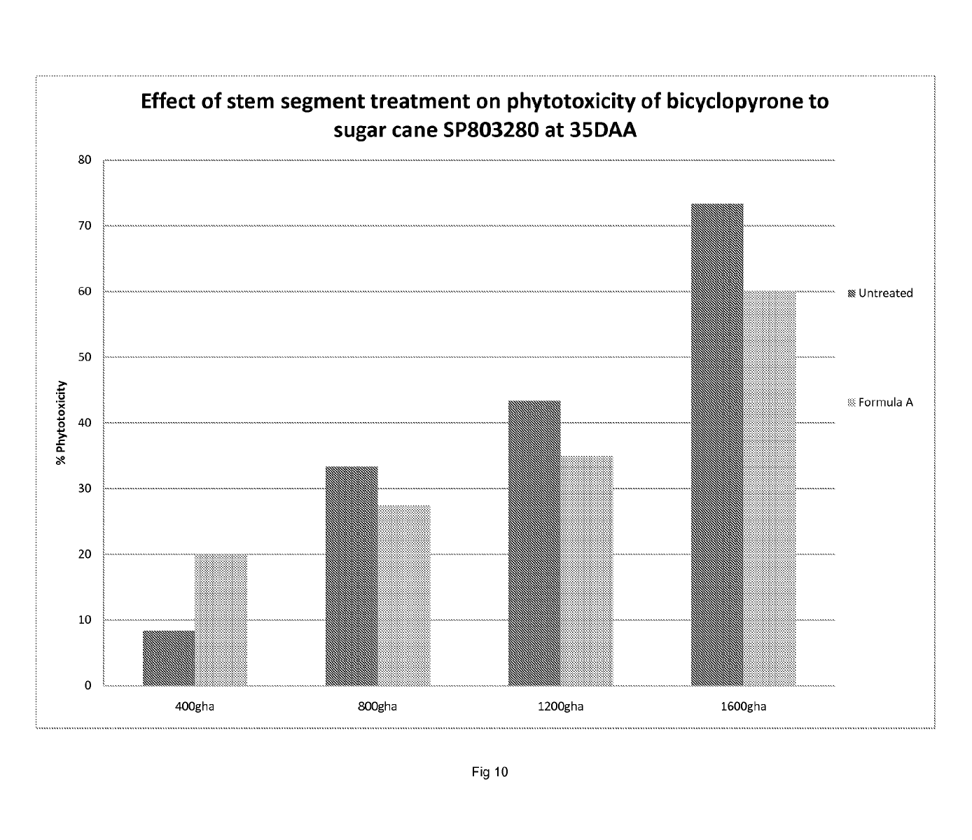

FIG. 10: 35 DAA—bicyclopyrone—SP803280

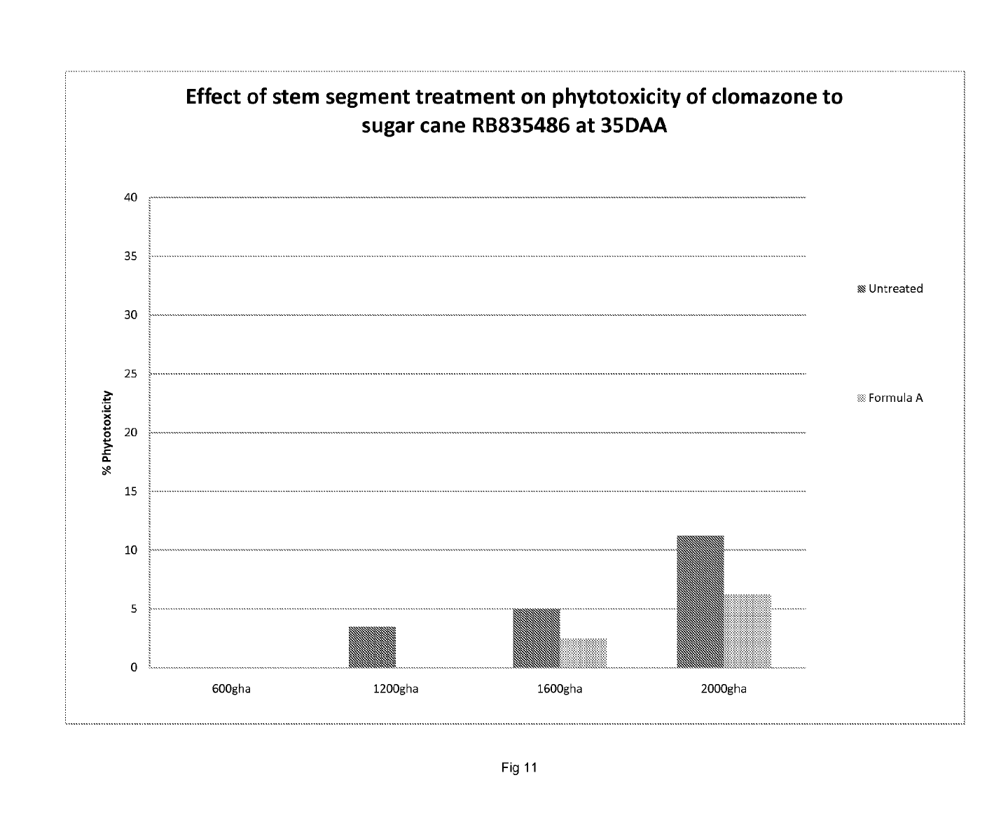

FIG. 11: 35 DAA—clomazone-RB835486

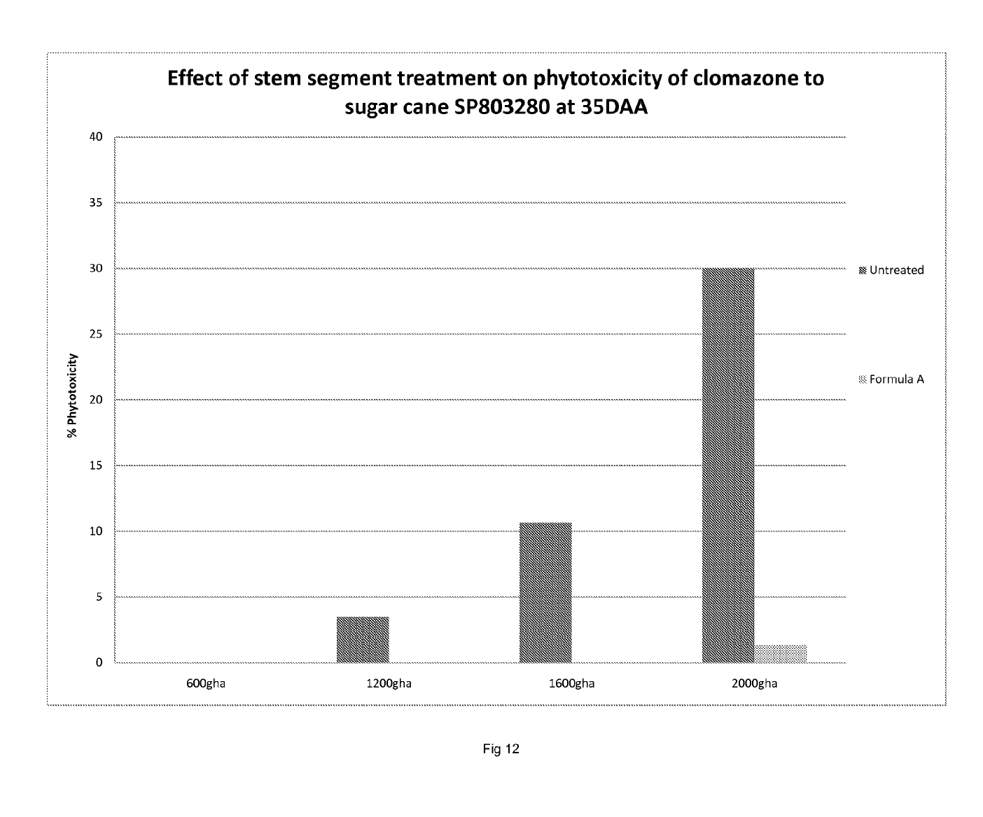

FIG. 12: 35 DAA—clomazone—SP803280

FIGS. 1-12 show the use of Formula A as a sugar cane propagation material applied safener displayed a clear safening effect with all three herbicides. The herbicides are of three different modes-of-action and show a broad safening effect of Formula A when applied as a propagation material treatment in sugar cane. Formula A safened sulfentrazone very effectively in both varieties of sugar cane, reducing 80% phytotoxicity levels to zero in certain instances. Formula A also showed strong safening of clomazone and bicyclopyrone.

The herbicides and their respective modes-of-action tested in the experiments are known in art. Other herbicides having the same classified mode-of-action are also contemplated in the scope of the present technology. PPO herbicides include, for example, acifluorfen-Na, bifenox, chlomethoxyfen, fluoroglycofen-ethyl, fomesafen, alosafen, lactofen, oxyfluorfen, fluazolate, pyraflufen-ethyl, cinidon-ethyl, flumioxazin, flumiclorac-pentyl, fluthiacet-methyl, thidiazimin, oxadiazon, oxadiargyl, azafenidin, carfentrazone-ethyl, sulfentrazone, pentoxazone, benzfendizone, butafenacil, pyraclonil, profluazol, and flufenpyr-ethyl. HPPD herbicides include, for example, mesotrione, sulcotrione, isoxachlortole, isoxaflutole, benzobicyclon, benzofenap, pyrazolynate, pyrazoxyfen, pyrasulfotole, benzobicyclon, topramezone, tefuryltrione, tembotrione, and bicyclopyrone. DOXP herbicides include, for example, clomazone.

1. A method for protecting sugar cane against the harmful of effects of herbicides comprising:
applying, to a sugar cane propagation material, a herbicidally antagonistically effective amount of a N-acylsulfamoylphenylurea of the formula (II) or formula (III): 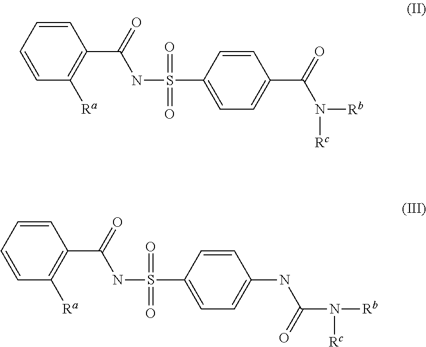
or an agronomically acceptable salt of said compounds, wherein:
R^{a} is selected from the group consisting of halogen, nitro, C₁-C₄ alkyl, C₁-C₄ haloalkyl, C₁-C₄ haloalkoxy, C₃-C₆ cycloalkyl, phenyl, C₁-C₄ alkoxy, cyano, C₁-C₄ alkylthio, C₁-C₄ alkylsulfinyl, C₁-C₄ alkylsulfonyl, C₁-C₄ alkoxycarbonyl and C₁-C₄ alkylcarbonyl; and
R^{b} and R^{c} are independently selected from the group consisting of hydrogen, C₁-C₆ alkyl, C₃-C₆ cycloalkyl, C₃-C₆ alkenyl and C₃-C₆ alkynyl.

2. The method of claim 1 wherein the N-acylsulfamoylphenylurea is of the formula (III) as defined in claim 1, and wherein R^{a} is C₁-C₄ alkoxy; R^{b} is C₁-C₆ alkyl; and R^{c} is hydrogen

3. A method of reducing the phytotoxicity of herbicides to sugar cane plants, the method comprising:
applying to a sugar cane propagation material, prior to sowing the propagation materiel, a phytotoxicity reducing effective amount of a N-acylsulfamoylphenylurea of the formula (II) or formula (III): 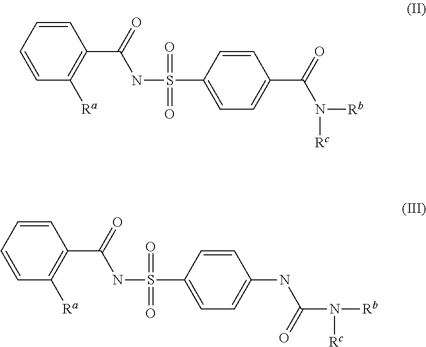
or an agronomically acceptable salt of said compounds, wherein:
R^{a} is selected from the group consisting of halogen, nitro, C₁-C₄ alkyl, C₁-C₄ haloalkyl, C₁-C₄ haloalkoxy, C₃-C₆ cycloalkyl, phenyl, C₁-C₄ alkoxy, cyano, C₁-C₄ alkylthio, C₁-C₄ alkylsulfinyl, C₁-C₄ alkylsulfonyl, C₁-C₄ alkoxycarbonyl and C₁-C₄ alkylcarbonyl; and
R^{b} and R^{c} are independently selected from the group consisting of hydrogen, C₁-C₆ alkyl, C₃-C₆ cycloalkyl, C₃-C₆ alkenyl and C₃-C₆ alkynyl.

4. The method of claim 3 wherein the N-acylsulfamoylphenylurea is of the formula (III) as defined in claim 3, and wherein R^{a} is C₁-C₄ alkoxy; R^{b} is C₁-C₆ alkyl; and R^{c} is hydrogen

5. (canceled)

6. (canceled)

7. Sugarcane propagation material treated with a phytotoxicity reducing effective amount of a N-acylsulfamoylphenylurea of the formula (II) or formula (III): 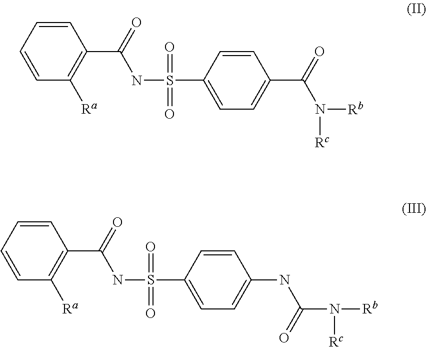
or an agronomically acceptable salt of said compounds, wherein:
R^{a} is selected from the group consisting of halogen, nitro, C₁-C₄ alkyl, C₁-C₄ haloalkyl, C₁-C₄ haloalkoxy, C₃-C₆ cycloalkyl, phenyl, C₁-C₄ alkoxy, cyano, C₁-C₄ alkylthio, C₁-C₄ alkylsulfinyl, C₁-C₄ alkylsulfonyl, C₁-C₄ alkoxycarbonyl and C₁-C₄ alkylcarbonyl; and
R^{b} and R^{c} are independently selected from the group consisting of hydrogen, C₁-C₆ alkyl, C₃-C₆ cycloalkyl, C₃-C₆ alkenyl and C₃-C₆ alkynyl.

8. The sugarcane propagation material of claim 7, wherein the N-acylsulfamoylphenylurea is of the formula (III) as defined in claim 8, and wherein R^{a} is C₁-C₄ alkoxy; R^{b} is C₁-C₆ alkyl; and R^{c} is hydrogen.

9. The sugarcane propagation material of claim 8, wherein the propagation material is a single-node sugarcane stem section.

10. A method of selectively controlling weeds at a locus having planted sugar cane propagation material and weeds present, the method comprising:
applying to the locus, a weed controlling amount of a herbicide; and wherein the sugar cane propagation material is treated with phytotoxicity reducing effective amount of a N-acylsulfamoylphenylurea of the formula (II) or formula (III): 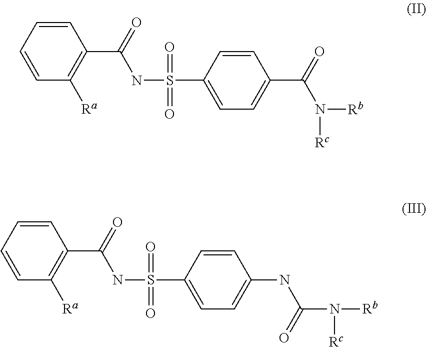
or an agronomically acceptable salt of said compounds, wherein:
R^{a} is selected from the group consisting of halogen, nitro, C₁-C₄ alkyl, C₁-C₄ haloalkyl, C₁-C₄ haloalkoxy, C₃-C₆ cycloalkyl, phenyl, C₁-C₄ alkoxy, cyano, C₁-C₄ alkylthio, C₁-C₄ alkylsulfinyl, C₁-C₄ alkylsulfonyl, C₁-C₄ alkoxycarbonyl and C₁-C₄ alkylcarbonyl; and
R^{b} and R^{c} are independently selected from the group consisting of hydrogen, C₁-C₆ alkyl, C₃-C₆ cycloalkyl, C₃-C₆ alkenyl and C₃-C₆ alkynyl.

11. The method of claim 10, wherein the herbicide has a mode-of-action selected from inhibition of the 1-desoxy-D-xylulose 5-phosphate, inhibition of protoporphyrinogen oxidase, or inhibition of the enzyme 4-hydoxyphenylpyruvate dioxygenase.

12. The method of claim 10, wherein the herbicide is selected from sulfonylureas, haloacetanilides, or aryloxyphenoxypropionic acid derivatives.

13. (canceled)

14. The method of claim 1 wherein the N-acylsulfamoylphenylurea is 1-[4-(N-2-methoxybenzoylsulfamoyl)phenyl]-3-methylurea.

15. The method of claim 3 wherein the N-acylsulfamoylphenylurea is 1-[4-(N-2-methoxybenzoylsulfamoyl)phenyl]-3-methylurea.

16. The method of claim 10 wherein the N-acylsulfamoylphenylurea is 1-[4-(N-2-methoxybenzoylsulfamoyl)phenyl]-3-methylurea.

17. The use of claim 13 wherein the N-acylsulfamoylphenylurea is 1-[4-(N-2-methoxybenzoylsulfamoyl)phenyl]-3-methylurea.
